(19) United States
(12) Patent Application Publication
(10) Pub. No.: US 2022/0397769 A1
(43) Pub. Date: Dec. 15, 2022

(54) IMAGE STITCHING-BASED AERIAL IMAGE FORMATION APPARATUS

(71) Applicant: Zhejiang Prism Holographic Technology Co., Ltd., Zhejiang (CN)

(72) Inventors: Xingfu ZHU, Zhejiang (CN); Xianchu PENG, Zhejiang (CN); Peiying JIANG, Zhejiang (CN)

(73) Assignee: Zhejiang Prism Holographic Technology Co., Ltd., Zhejiang (CN)

(21) Appl. No.: 17/835,969

(22) Filed: Jun. 9, 2022

(30) Foreign Application Priority Data
Jun. 10, 2021 (CN) 202121289771.9

(51) Int. Cl. G02B 30/56; G02B 9/04

(52) U.S. Cl. CPC G02B 30/56; G02B 9/04

(57) ABSTRACT

Disclosed is an image stitching-based aerial image formation apparatus, including: two image sources, rear lenses and a front lens, wherein partial display contents of the two image sources overlap; the rear lenses are in one-to-one correspondence with the image sources and have a positive focal lens; the front lens is configured to converge the light rays, which have passed through the rear lenses, into a real image; the two image sources are respectively located at two sides of the plane passing through the main axis of the front lens; the images displayed by the two image sources, after having respectively passed the rear lenses and the front lens, are stitched into a real image which is a complete image.

### CROSS-REFERENCE TO RELATED APPLICATION

This application claims the priority benefit of China application no. 202121289771.9, filed on Jun. 10, 2021. The entirety of the above-mentioned patent application is hereby incorporated by reference and made a part of this specification.

### FIELD

The disclosure relates to an image stitching-based aerial image formation apparatus.

### BACKGROUND

A conventional aerial image formation apparatus mainly produces a real image in midair after an image generated from an image source passes through an optical element such as a lens group or a dihedral corner reflector. FIG. 1 illustrates such a conventional aerial image formation apparatus, comprising an image source 1 which presents an image, a rear lens 3 and a front lens 4 which perform achromatization to the image, and a reflective mirror which adjusts the angle of the achromatized image to control the position where a real image 5 is rendered. As the technologies for aerial image formation apparatuses become more and more mature, their applications are increasingly wide with assistance of a gesture recognition apparatus. However, in some limited spaces, e.g., inside a vehicle, the conventional aerial image formation apparatus is unadaptable for installation in the vehicle dashboard owing to complex longitudinal dimension requirements; if it is forcibly installed in the vehicle dashboard, the image size it renders would be affected, mainly because the chromatic aberration of the front lens is usually compensated at the rear lens, which requires the heights of light rays in the same field of view on the front and rear lenses be distributed at different sides of the optical axis, such that the size of the aerial image formation apparatus is uncompressible in the longitudinal direction.

### SUMMARY

The disclosure provides an aerial image formation apparatus and an image source display content determining method, which can effectively solve a problem that a conventional aerial image formation apparatus is unadaptable for installation in a space with a limited longitudinal dimension.

An image stitching-based aerial image formation apparatus comprises sequentially in an optical path direction:

image sources, wherein two image sources are provided, and partial display contents of the two image sources overlap;

rear lenses in one-to-one correspondence with the image sources, wherein an equivalent focal length of each rear lens is a positive focal length for compensating longitudinal axis chromatic aberration;

a front lens configured to converge light rays, which have respectively passed through the rear lenses, into a real image;

wherein the two image sources are respectively disposed at two sides of a plane passing through a principal axis of the front lens, and the images displayed by the two image sources, after having respectively passed through the rear lenses and the front lens, are stitched into a real image which is a complete image.

Preferably, a first reflective mirror is further provided between each rear lens and the front lens, the first reflective mirror being configured to change the angle of the light ray passing through the rear lens.

Preferably, a second reflective mirror is further provided between the front lens and the real image, the second reflective mirror being configured to change position of the real image.

Preferably, each rear lens is comprised of a single lens or a plurality of lenses; and the front lens is comprised of a single lens or a plurality of lenses.

Preferably, each image source comprises at least two sub-image sources, and partial display contents of two adjacent sub-image sources overlap. By further splitting the image source into at least two sub-image sources, the size of individual image sources is reduced, which facilitates setting of the sub-image sources and enables sufficient utilization of available space.

Preferably, a third reflective mirror is provided between each sub-image source and the corresponding rear lens. The third reflective mirror enables adjustment of the position of the sub-image source, allowing the light ray emitted from the sub-image source to pass through the corresponding rear lens.

Preferably, each rear lens comprises sub-rear lenses. The number of the sub-rear lenses corresponds to that of the sub-image sources. Each sub-image source corresponds to one sub-rear lens. By further splitting the rear lens into at least two sub-rear lenses, the distribution manner and flexibility of the components on the optical path upstream of the front lens are further improved so as to sufficiently utilize the available space.

Compared with conventional technologies, the disclosure offers the following benefits: the image stitching-based aerial image formation apparatus enables shrinkage of the size of individual image sources by splitting each image source into two; and by further configuring a rear lens separately for each image source, the size in longitudinal direction may be further shrunk while compensating the longitudinal axis chromatic aberration; in this way, the whole apparatus is downsized in the longitudinal direction so as to be better adapted for installation in a narrow space; moreover, the apparatus of the disclosure is easier for batch production and commercial application.

### BRIEF DESCRIPTION OF THE DRAWINGS

FIG. 1 is a structural schematic diagram of a conventional aerial image formation apparatus;

FIG. 2 is structural schematic diagram of an aerial image formation apparatus according to the disclosure;

FIG. 3 is an optical path diagram for image source stitching in a first example of an image source display content determining method that employs the aerial image formation apparatus of the disclosure.

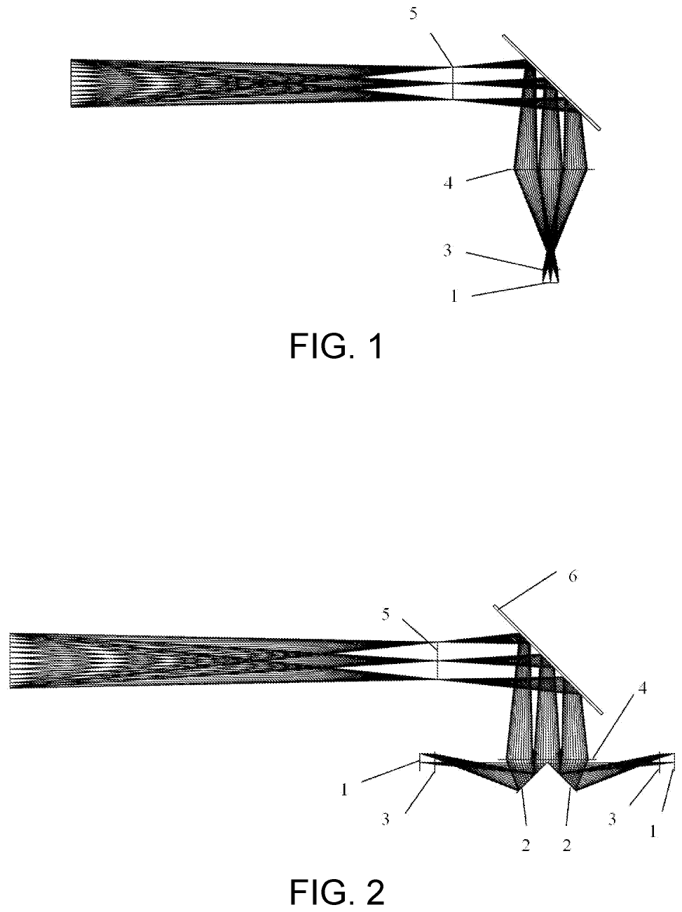

### DETAILED DESCRIPTION

Hereinafter, embodiments of the disclosure will be described in detail. Exemplary embodiments are shown in the drawings. The embodiments described with reference to the accompanying drawings are intended to explain the disclosure, which shall not be construed as limiting the disclosure.

In the description of the disclosure, it needs to be understood that the orientational or positional relationships indicated by the terms “center,” “longitudinal,” “transverse,” “length,” “width,” “thickness”, “upper,” “lower,” “front,” “rear,” “left,” “right,” “vertical,” “horizontal,” “top,” “bottom,” “inner,” and “outer,” etc. are orientational and positional relationships based on the drawings, which are intended only for facilitating or simplifying description of the disclosure, not for indicating or implying that the devices or elements have to possess those specific orientations and have to be configured and operated with such specific orientations; therefore, they should not be understood as limitations to the disclosure.

In addition, the terms “first” and “second” are only used for description purposes, which shall not be construed as indicating or implying a relative importance or implicitly indicating the number of the technical features indicated. Therefore, the features limited by “first” and “second” may explicitly or implicitly include at least one of such features. In the description of the disclosure, “plurality” indicates at least two, for example, two, three, etc., unless otherwise indicated.

In the disclosure, unless otherwise explicitly provided and limited, the terms such as “mount,” “connect,” “attach,” and “fix” should be understood broadly, which, for example, may refer to a secured connection, a detachable connection, or an integral connection; which may be a mechanical connection or an electrical connection; which may be a direct connection or an indirect connection via an intermediate medium; which may also be a communication between the insides of two elements or the interactive relationships between the two elements, unless otherwise explicitly defined. To a person of normal skill in the art, specific meanings of the above terms in the disclosure may be understood based on specific situations.

### First Example:

FIG. 2 illustrates an example of an image stitching-based aerial image formation apparatus according to the disclosure, wherein the aerial image formation apparatus comprises a primary aerial image formation unit, the aerial image formation unit comprising sequentially in the optical path direction:

image sources 1, wherein two image sources 1 are provided, and partial display contents of the two image sources 1 overlap so as to facilitate stitching of the light rays, which are emitted from the two image sources 1 and have passed through the subsequent lens group, into a complete real image 5; the image sources 1 in this example are LCDs, which, of course, may also be one of LEDs, OLEDs, or LCOSs;

rear lenses 3 in one-to-one correspondence with the image sources 1, wherein an equivalent focal length of each rear lens 3 is a positive focal length for compensating longitudinal axial chromatic aberration; and

a front lens 4 configured to converge light rays, which have respectively passed through the rear lenses 3, into a real image 5;

wherein the two image sources 1 are respectively disposed at two sides of a plane passing through a principal axis of the front lens 4, and the images displayed by the two image sources 1, after having respectively passed through the rear lenses 3 and the front lens 4, are stitched into the real image 5 which is a complete image.

To further compress the space in longitudinal direction, a first reflective mirror 2 is provided between each rear lens 3 and the front lens 4. The first reflective mirror 2 is usually a plane mirror, which may change the angle of the light ray between the rear lens 3 and the front lens 4 so as to change the corresponding image source 1 from the vertical position to the horizontal position, thereby compressing the space in longitudinal direction, such that the transverse space is utilized.

A second reflective mirror 6 is further provided between the front lens 4 and the real image 5. The second reflective mirror 6 may be a standalone lens; when the aerial image formation apparatus of the disclosure is mounted on a vehicle, the windshield glass of the vehicle may also serve as the second reflective mirror 6; this may change the position of the rendered real image 5 such that the real image 5 is at an angle more suitable for human eyes to view.

In this example, dependent on a specific application scenario and cost control, the rear lenses 3 and the front lens 4 may be comprised of a single lens or a lens group comprising a plurality of lenses. The lens group is preferable to remove the axial chromatic aberration and render a more definite image quality.

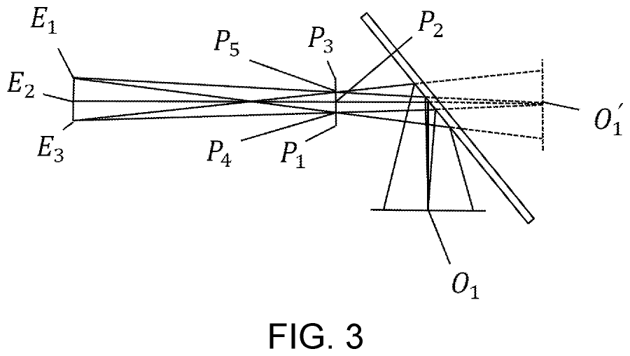

As illustrated in FIG. 3, since in this example the rendered real image 5 is obtained from stitching the images from two image sources 1, it is needed to determine the image content displayed by each image source 1. A specific determining method comprises steps of:

Step 1: determining a viewer's distance and viewing range, wherein two endpoints of the viewer's viewing range are denoted as E₁, E₃, respectively, and the midpoint thereof is denoted as E₂; determining positions of individual components in the aerial image formation unit, and determining position of the real image 5, wherein two endpoints of the real image 5 are denoted as P₁, P₃, and the midpoint thereof is denoted as P₂; and determining the center position O₁ of the front lens 4;

Step 2: connecting E₁ and O₁ to intersect with P₁P₃ at point P₅, connecting E₃ and O₁ to intersect with P₁P₃ at point P₄, and then P₂P₄=P₂P₅=E₁E₂×O₁P₂÷O₁E₂; and resolving the positions P₄, P₅, wherein P₁P_{S} corresponds to the content in the aerial image area displayed by the left image source 1, and P₃P₄ corresponds to the content in the aerial image area displayed by the right image source 1;

When a second reflective mirror 6 is provided between the front lens 4 and the real image 5 and the second reflective mirror 6 is a plane mirror, in Step 1, the center position O₄ of the first lens 4 is first mirrored about the second reflective mirror 6 to obtain 0₁′, and in Step 2, O₁ is replaced with O₁′ to compute;

If the first reflective mirror 2 and the second reflective mirror 6 are both provided in the aerial image formation apparatus and the second reflective mirror 6 is a curved reflective mirror, a specific method of determining the image content displayed by each image source 1 comprises steps of:

Step 1: determining a viewer's distance and viewing range, wherein two endpoints of the viewer's viewing range are denoted as E₁, E₃, and the midpoint thereof is denoted as E₂; determining positions of individual components in the aerial image formation unit, and determining position of the real image 5, wherein two endpoints of the real image 5 are denoted as P₁, P₃, respectively, and the midpoint thereof is denoted as P₂; wherein the left first reflective mirror is denoted as M₁, and the right first reflective mirror is denoted as M₂;

Step 2: estimating positions of points P₄, P₅ on P₁, P₃;

Step 3: performing reverse tracking of the optical path, wherein the light rays are emitted from P₄, P₅, and beam diameters of the light rays are determined based on the sizes of E₁, E₂; adjusting the position of P₄, such that when the light ray emitted from P₄ only passes through

M₂, P₃P₄ corresponds to the content of the aerial image area displayed by the right image source 1; and adjusting the position of P₅, such that when the light ray emitted from P₅ just only passes through M₁, P₁P₅ corresponds to the content of the aerial image area displayed by the left image source 1.

The image stitching-based aerial image formation apparatus enables size shrinkage of individual image sources by splitting the image source into two, and by further configuring a rear lens separately for each image source, the size in longitudinal direction may be further shrunk while compensating the longitudinal axis chromatic aberration, causing longitudinal dimension shrinkage of the whole apparatus so as to be better adapted for installation in a narrow space; moreover, the apparatus of the disclosure is easier for batch production and commercial application.

The method of determining the image source display content is simple and easy to operate; by determining the amount of the display content of each image source based on the viewer's distance and viewing range, the real image rendered by each image source is superimposed to form a larger complete image.

### Second Example

This example differs from the first example in further splitting each image source in the first example into at least two sub-image sources. Here, an example of decomposing one image source into two sub-image sources will be explained, i.e., the image source at the left side of the principal axis of the front lens is comprised of two sub-image sources, and the image source at the right side of the principal axis of the front lens is also comprised of two sub-image sources. The remaining components other than the image sources in the whole image stitching-based aerial image formation apparatus maintain unchanged, and only the image contents displayed by sub-image sources are required to partially overlap, so as to ensure that no seam is generated when stitching the images. In this way, the individual sub-image source may be downsized to sufficiently utilize the narrow space.

Furthermore, a third reflective mirror may be provided for each sub-image source, wherein the third reflective mirror is mounted between each sub-image source and the corresponding rear lens, which may further scale the configurable angle and position of the sub-image source.

The rear lens may also be split into a plurality of sub-rear lenses, wherein structures of individual sub-rear lenses are consistent. This offers a larger layout space for the components upstream of the front lens optical path, so as to sufficiently utilize the whole spatial size through arrangement of different sub-image sources, sub-rear lenses and/or the third reflective mirrors.

As to which specific portions of the image contents displayed by respective image sources are required to overlap, it may be determined with reference to the method described in the first example.

By splitting each image source 1 into two sub-image sources, the size of individual sub-image sources is shrunk, and by configuring a sub-rear lens separately for each sub-image source, the size in longitudinal direction may be shrunk while compensating the longitudinal axis chromatic aberration, thereby shrinking the longitudinal dimension of the whole apparatus so as to be better adapted for installation in a narrow space; moreover, the apparatus of the disclosure is easier for batch production and commercial application.

What have been discussed above are only preferred embodiments of the disclosure; however, the technical features of the disclosure are not limited thereto; any change or modification made by a person of normal skill in the art should be covered in the scope of the disclosure.

What is claimed is:

1. An image stitching-based aerial image formation apparatus, comprising sequentially in an optical path direction:
image sources, wherein two image sources are provided, and partial display contents of the two image sources overlap;
rear lenses in one-to-one correspondence with the image sources, wherein an equivalent focal length is a positive focal length for compensating a longitudinal axis chromatic aberration;
and a front lens configured to converge light rays, which have respectively passed through the rear lenses, into a real image;
wherein the two image sources are respectively disposed at two sides of a plane passing through a principal axis of the front lens, and images displayed by the two image sources, after having respectively passed through the rear lenses and the front lens, are stitched into the real image which is a complete image.

2. The image stitching-based aerial image formation apparatus of claim 1, wherein a first reflective mirror is further provided between each rear lens and the front lens, the first reflective mirror being configured to change an angle of the light ray which has passed through the rear lens.

3. The image stitching-based aerial image formation apparatus of claim 1, wherein a second reflective mirror is further provided between the front lens and the real image, the second reflective mirror being configured to change a position of the real image.

4. The image stitching-based aerial image formation apparatus of claim 1, wherein each rear lens is comprised of a single lens or a plurality of lenses; the front lens is comprised of a single lens or a plurality of lenses.

5. The image stitching-based aerial image formation apparatus of claim 1, wherein each of the image sources comprises at least two sub-image sources, and partial display contents of two adjacent sub-image sources overlap.

6. The image stitching-based aerial image formation apparatus of claim 5, wherein a third reflective mirror is provided between each sub-image source and the corresponding rear lens.

7. The image stitching-based aerial image formation apparatus of claim 5, wherein each of the rear lenses comprises sub-rear lenses, the number of the sub-rear lenses corresponds to that of the sub-image sources, each sub-image source corresponds to one sub-rear lens.

8. The image stitching-based aerial image formation apparatus of claim 6, wherein each of the rear lenses comprises sub-rear lenses, the number of the sub-rear lenses correspond to that of the sub-image sources, each sub-image source corresponds to one sub-rear lens.
